(19) United States
(12) Patent Application Publication
(10) Pub. No.: US 2012/0105379 A1
(43) Pub. Date: May 3, 2012

(54) COORDINATE RECOGNITION APPARATUS AND COORDINATE RECOGNITION METHOD

(75) Inventors: Sadatoshi OISHI, Shizuoka-ken (JP); Yuishi Takeno, Shizuoka-ken (JP); Takuya Ogishima, Shizuoka-ken (JP)

(73) Assignee: Toshiba Tec Kabushiki Kaisha, Tokyo (JP)

(21) Appl. No.: 13/286,738

(22) Filed: Nov. 1, 2011

Related U.S. Application Data
(60) Provisional application No. 61/409,930, filed on Nov. 3, 2010.

(51) Int. Cl. G06F 3/042

(52) U.S. Cl. 345/175

(57) ABSTRACT

According to one embodiment, a coordinate recognition apparatus includes a coordinate input unit, an adjustment unit, a judgment unit, a scan control unit, and a recognition unit. The adjustment unit adjusts an offset voltage of a sensor amplifier that amplifies a sensor signal output from the light-receiving element. The judgment unit judges whether disturbance light received by the light-receiving element has an influence. The scan control unit sets the number of scans with the light beam to scan the coordinate input unit when the judgment unit judges that the disturbance light has an influence to be greater than the number of scans when the judgment unit judges that the disturbance light has no influence. The recognition unit recognizes the coordinates input by the coordinate input unit in accordance with a change of the sensor signal output from the light-receiving element.

### CROSS-REFERENCE TO RELATED APPLICATIONS

This application is based upon and claims the benefit of priority from prior Japanese Patent Application No. 61/409,930, filed on Nov. 3, 2010, the entire contents of which are incorporated herein by reference.

### FIELD

Embodiments described herein relate generally to a coordinate recognition apparatus and a coordinate recognition method wherein an optical touch panel is used as a coordinate input unit.

### BACKGROUND

A coordinate recognition apparatus that uses an optical touch panel as a coordinate input unit is known. In the optical touch panel, if strong infrared light such as sunlight is applied to a photosensor which is a light-receiving element, the photosensor cannot detect a signal of a light-emitting element. Therefore, the coordinate recognition apparatus may misjudge coordinates.

In order to solve this problem, the light-receiving element can be surrounded by a frame. However, when the light-receiving element is surrounded by the frame, the light-receiving element can only receive a light beam of the light-emitting element that faces this light-receiving element. Thus, the coordinate recognition apparatus cannot improve resolution.

A coordinate recognition apparatus having high resolution and high coordinate judgment accuracy is demanded.

### BRIEF DESCRIPTION OF THE DRAWINGS

FIG. 1 is a block diagram showing the overall configuration of a coordinate recognition apparatus according to one embodiment;

FIG. 2 is a schematic diagram showing a coordinate input unit of the coordinate recognition apparatus according to the embodiment;

FIG. 3 is a block diagram showing functions enabled by a CPU of the coordinate recognition apparatus according to the embodiment through a coordinate recognition program;

FIG. 4 is a schematic diagram showing an offset voltage memory formed in a RAM of the coordinate recognition apparatus according to the embodiment;

FIG. 5 is a flowchart showing the first half of a processing routine to be performed in accordance with the coordinate recognition program by the CPU of the coordinate recognition apparatus according to the embodiment; and

FIG. 6 is a flowchart showing the second half of the processing routine to be performed in accordance with the coordinate recognition program by the CPU of the coordinate recognition apparatus according to the embodiment.

### DETAILED DESCRIPTION

In general, according to one embodiment, a coordinate recognition apparatus includes a coordinate input unit, an adjustment unit, a judgment unit, a scan control unit, and a recognition unit. The coordinate input unit inputs coordinates of a light-blocking position by the blockage of a light beam to scan a space between a light-emitting element and a light-receiving element that are disposed to face each other. The adjustment unit adjusts an offset voltage of a sensor amplifier that amplifies a sensor signal output from the light-receiving element. The judgment unit judges whether disturbance light received by the light-receiving element has an influence in accordance with an adjustment value of the offset voltage. The scan control unit sets the number of scans with the light beam to scan the coordinate input unit when the judgment unit judges that the disturbance light has an influence to be greater than the number of scans when the judgment unit judges that the disturbance light has no influence. The recognition unit recognizes the coordinates input by the coordinate input unit in accordance with a change of the sensor signal output from the light-receiving element.

Embodiments of a coordinate recognition apparatus that uses an infrared optical touch panel as a coordinate input unit is described below. The embodiments relate to a coordinate recognition apparatus and a coordinate recognition method that can minimize the influence of disturbance light such as sunlight, if any, entering a light-receiving element.

### First Embodiment

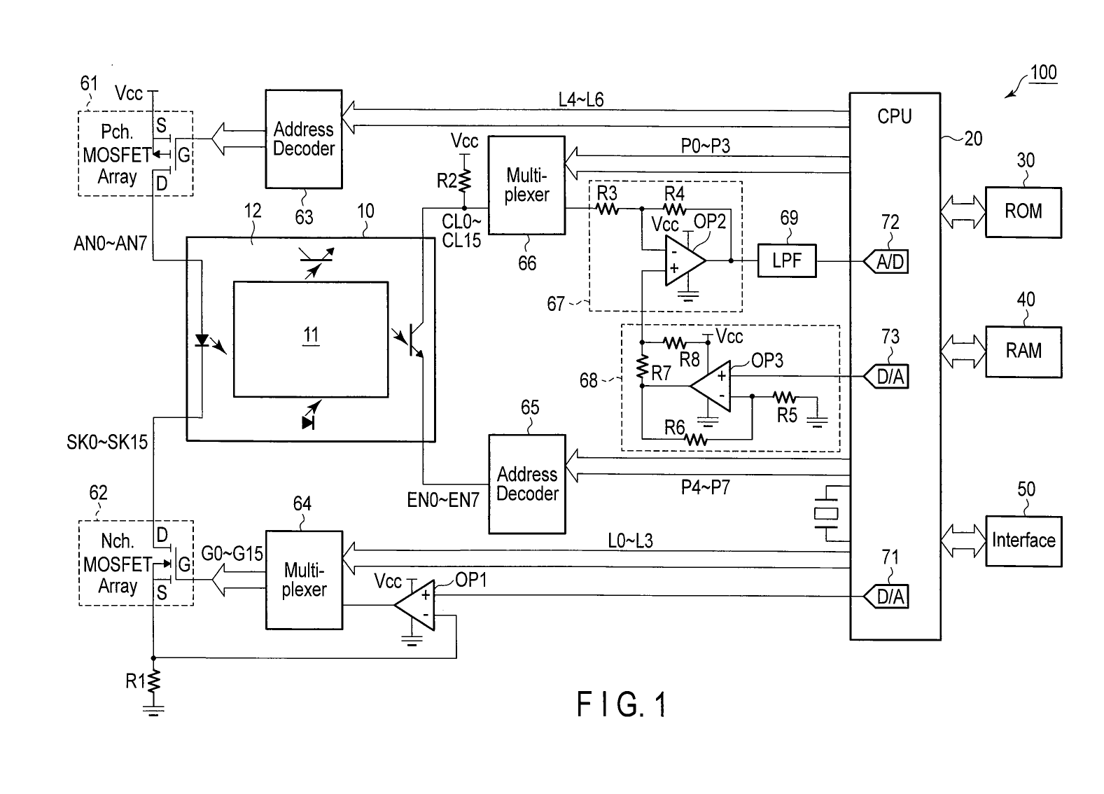

FIG. 1 is a block diagram showing the overall configuration of a coordinate recognition apparatus 100 according to the embodiment. The coordinate recognition apparatus includes a coordinate input unit 10, a central processing unit (CPU) 20 as a controller, a read only memory (ROM) 30 and a random access memory (RAM) 40 as main memories, and an interface 50. Although not shown, the interface 50 is connected to a host computer by a serial communication such as a universal asynchronous receiver transmitter (UART) or a universal serial bus (USB).

The coordinate input unit 10 includes a rectangular panel 11, and a touch ring 12 disposed on the outer peripheral portion of the panel 11. The panel 11 is a transparent acrylic plate or a reinforced glass plate, and is disposed on a screen of, for example, a liquid crystal display (LCD) or a cathode ray tube (CRT). The screen of the LCD or the CRT may be directly used as the panel 11.

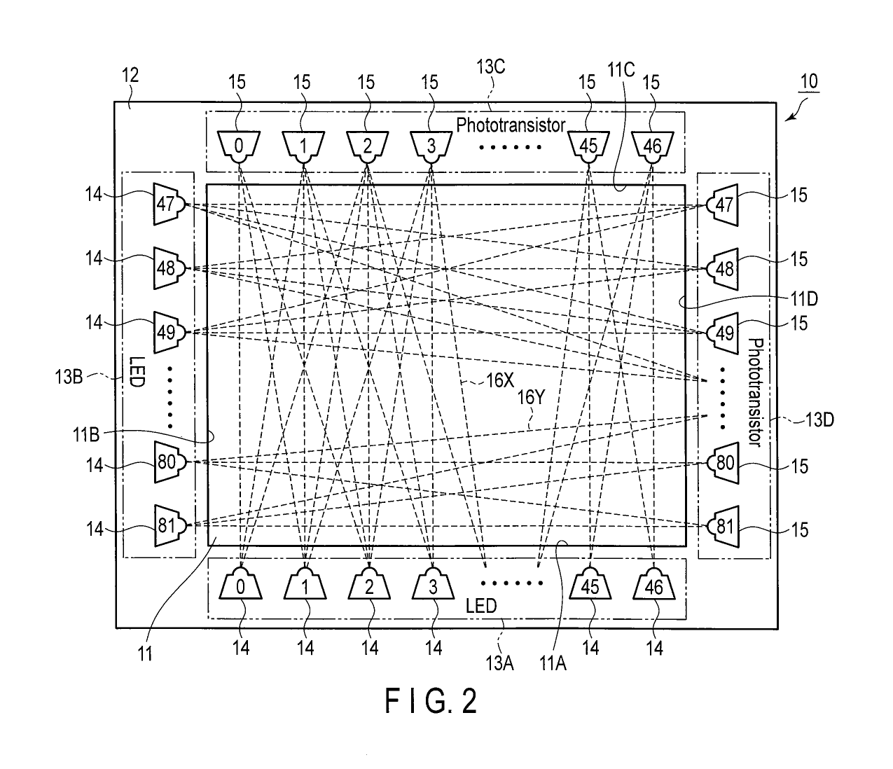

As shown in FIG. 2, the touch ring 12 arranges light-emitting portions 13A and 13B along a first side 11A which is one side of the panel 11 and a second side 11B perpendicular to the first side 11A. The touch ring 12 also arranges light-receiving portions 13C and 13D along a third side 110 which faces the first side 11A of the panel 11 and a fourth side 11D which faces the second side 11B.

The light-emitting portions 13A and 13B align LEDs 14 which are light-emitting elements (82 light-emitting elements in FIG. 2) at substantially regular intervals along the sides 11A and 11B of the panel 11. The light-receiving portions 13C and 13D align phototransistors 15 which are light-receiving elements equal in number to the light-emitting elements at substantially regular intervals along the sides 11C and 11D of the panel 11.

Accordingly, the LEDs 14 of the first light-emitting portion 13A face the phototransistors 15 of the first light-receiving portion 13C one to one. Similarly, the LEDs 14 of the second light-emitting portion 13B face the phototransistors 15 of the second light-receiving portion 13D one to one. As shown in FIG. 2, common unique addresses [0] to [81] are set to the LEDs 14 and the phototransistors 15 that face the LEDs 14.

Infrared LEDs which emit infrared light are used as the LEDs 14. The phototransistor 15 is characterized by its response time [μs] that shortens as irradiance [mw/cm²] increases. The emission wavelength of each infrared LED 14 and the reception wavelength of each phototransistor 15 are optimized at 800 [nm] to 950 [nm]. The LEDs 14 and the phototransistors 15 are not individually surrounded by frames.

In the coordinate input unit 10 having such a configuration, infrared light emitted from one LED 14 is not only received by the phototransistor 15 that faces this LED 14 but also received by the phototransistors 15 arranged on the right and left of the former phototransistor 15. Therefore, light beams 16X and 16Y much greater in number than the LEDs 14 and the phototransistors 15 are formed across one another on the panel 11.

In this condition, if a user touches the panel 11 with his/her finger, part of the light beam 16X formed between the first light-emitting portion 13A and the first light-receiving portion 13C and part of the light beam 16Y formed between the second light-emitting portion 13B and the second light-receiving portion 13D are blocked. A light-blocking position where the light beam 16X is blocked is input as an X coordinate to the coordinate input unit 10. Similarly, a light-blocking position where the light beam 16Y is blocked is input as a Y coordinate to the coordinate input unit 10.

The coordinate recognition apparatus 100 comprises, as drive circuits of the LEDs 14, a first MOSFET array 61, a second MOSFET array 62, a first address decoder 63, and a first multiplexer 64.

The first MOSFET array 61 has an array of eight P-channel MOSFETs. Each of the P-channel MOSFETs has a gate terminal G connected to the first address decoder 63, a source terminal S connected to a reference power source Vcc, and a drain terminal D connected to one end of each of eight signal lines AN0 to AN7. Anode terminals of the LEDs 14 disposed in the first and second light-emitting portions 13A and 13B are divided into eight groups, and connected in groups to the other end of each of the signal lines AN0 to AN7.

The first address decoder 63 switches on the gate of one P-channel MOSFET designated by address signals L4 to L6 input from the CPU 20.

The second MOSFET array 62 has an array of sixteen N-channel MOSFETs. Each of the N-channel MOSFETs has a gate terminal G connected to the 16-channel first multiplexer 64, a source terminal S connected to a ground via a resistance R1 for current detection, and a drain terminal D connected to one end of each of sixteen signal lines SK0 to SK15. Cathode terminals of the LEDs 14 disposed in the first and second light-emitting portions 13A and 13B are divided into sixteen groups, and connected in groups to the other end of each of the signal lines SK0 to SK15.

Here, the anode terminals and cathode terminals of the LEDs 14 are grouped so that the cathode terminals of the LEDs 14 having their anode terminals belonging to the same group belong to different groups.

The first multiplexer 64 switches on the gate of one N-channel MOSFET designated by address signals L0 to L3 input from the CPU 20. In response to an output of an operational amplifier OP1, the first multiplexer 64 sets a forward current of the LED 14 having the cathode terminal connected to the drain terminal D of the N-channel MOSFET having its gate switched on.

The operational amplifier OP1 connects a noninverting input terminal (+) to a digital/analog (D/A) converter 71, and connects an inverting input terminal (−) to a connection point between the source terminal S of each N-channel MOSFET and the resistance R1. As a result, a feedback loop including the N-channel MOSFET having its gate switched on by the first multiplexer 64 is formed.

The CPU 20 outputs a reference voltage signal from the D/A converter 71. For example, suppose that a reference voltage signal having a reference voltage 1 [V] is output from the D/A converter 71. In this case, if the resistance R1 is 5 [Ω], the forward current of each LED 14 is 200 [mA]. Accordingly, a current of 200 [mA] also runs through the resistance R1, so that the feedback loop acts to produce a voltage drop of 1 [V]. Thus, the first multiplexer 64 selects a group of LEDs 14 and provides a constant current circuit at the same time.

Here, one LED 14 is only selected by the first multiplexer 64 among one group of LEDs 14 selected by the first address decoder 63. This selected LED 14 emits light by a forward current corresponding to the reference voltage signal from the D/A converter 71. The emission intensity in this case is proportional to the intensity of the forward current.

The coordinate recognition apparatus 100 comprises, as drive circuits of the phototransistors 15, a second address decoder 65, a second multiplexer 66, a sensor amplifier 67, an offset voltage adjustment circuit 68, and a low pass filter 69.

The second address decoder 65 connects one end of each of eight signal lines EN0 to EN7. Emitter terminals of the phototransistors 15 disposed in the first and second light-receiving portions 13C and 13D are divided into eight groups, and connected in groups to the other end of each of the signal lines EN0 to EN7.

The second address decoder 65 activates one group of phototransistors 15 designated by address signals P4 to P7 input from the CPU 20.

The second multiplexer 66 connects one end of each of sixteen signal lines CL0 to CL15. Collector terminals of the phototransistors 15 disposed in the first and second light-receiving portions 13C and 13D are divided into sixteen groups, and connected in groups to the other end of each of the signal lines CL0 to CL15.

Here, the emitter terminals and collector terminals of the phototransistors 15 are grouped so that the collector terminals of the phototransistors 15 having their emitter terminals belonging to the same group belong to different groups.

A reference voltage Vcc is applied to each of the signal lines CL0 to CL15 via a load resistance R2. The intensity of the load resistance R2 is related to the response performance of the phototransistor 15. When the load resistance R2 is low, the phototransistor 15 rapidly responds. In the present embodiment, the load resistance R2 is preferably about 100 [Ω].

The second multiplexer 66 selects a collector signal of one group of phototransistors 15 designated by address signals P0 to P3 input from the CPU 20. Here, one phototransistor 15 is only activated by the second address decoder 65 among one group of phototransistors 15. That is, the second multiplexer 66 outputs the collector signal of the selected one phototransistor 15 to the sensor amplifier 67.

The sensor amplifier 67 includes an operational amplifier OP2 and resistances R3 and R4. The operational amplifier OP2 inputs the collector signal selected by the second multiplexer 66 to the inverting input terminal (−) via the resistance R3, and inputs, to the noninverting input terminal (+), a control signal of an offset voltage which is an output of the offset voltage adjustment circuit 68. The operational amplifier OP2 feeds back an output signal to the inverting input terminal (−) via the resistance R4. Thus, the operational amplifier OP2 functions as an inverting amplifier circuit. The sensor amplifier 67 outputs the signal inverted and amplified by the operational amplifier OP2 to an A/D converter 72 via the low pass filter 69.

The offset voltage adjustment circuit 68 includes an operational amplifier OP3 and resistances R5, R6, R7, and R8. The operational amplifier OP3 inputs an adjustment signal for the offset voltage to the noninverting input terminal (+) from a D/A converter 73, and connects the ground to the inverting input terminal (−) via the resistance R5. The operational amplifier OP3 feeds back an output signal to the inverting input terminal (−) via the resistance R6.

The adjustment circuit 68 connects a series circuit of the resistance R7 and the resistance R8 between the output terminal of the operational amplifier OP3 and the input terminal of the reference voltage Vcc. The adjustment circuit 68 outputs a signal flowing through a connection point between the resistance R7 and the resistance R8 to the sensor amplifier 67 as a control signal of the offset voltage.

In this way, the coordinate recognition apparatus 100 takes out the collector signal of the phototransistor 15 as a sensor signal. Without any incident light, no collector signal runs through the phototransistor 15. Therefore, if the phototransistor 15 does not receive infrared light, the voltage of the sensor signal is substantially equal to a power supply voltage.

The coordinate recognition apparatus 100 uses the adjustment circuit 68 to adjust the offset voltage of the sensor amplifier 67 so that the output of the sensor amplifier 67 will be an optimum value. For this adjustment, feedback control that uses the algorithm of proportional-integral-derivative (PID) is utilized.

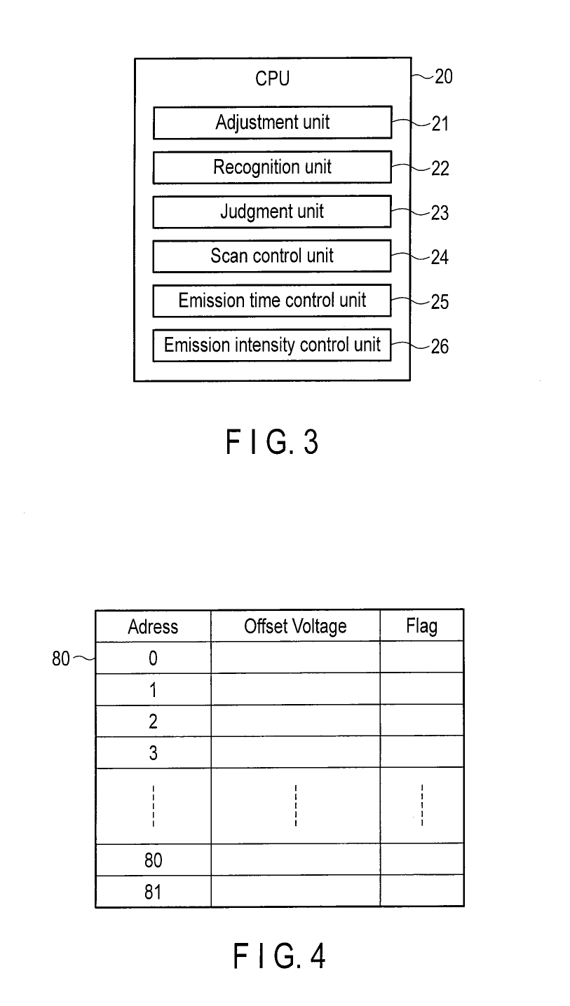

Fixed data such as a program is stored in the ROM 30. One program stored in this ROM 30 is a coordinate recognition program. The CPU 20 executes this coordinate recognition program to enable functions as an adjustment unit 21, a recognition unit 22, a judgment unit 23, a scan control unit 24, an emission time control unit 25, and an emission intensity control unit 26, as shown in FIG. 3.

The adjustment unit 21 adjusts the offset voltage of the sensor amplifier 67 which amplifies the sensor signal output from the phototransistor 15. The recognition unit 22 recognizes the X coordinate and the Y coordinate input by the coordinate input unit 10 in accordance with a change of the sensor signal. The judgment unit 23 judges whether disturbance light received by the phototransistors 15 has an influence in accordance with an adjustment value of the offset voltage.

The scan control unit 24 sets the number of scans with the light beams 16X and 16Y to scan the coordinate input unit 10 when the judgment unit 23 judges that the disturbance light has an influence to be greater than the number of scans when the judgment unit 23 judges that the disturbance light has no influence. The emission time control unit 25 sets the emission time of the LEDs 14 when the judgment unit 23 judges that the disturbance light has an influence to be shorter than the emission time when the judgment unit 23 judges that the disturbance light has no influence. The emission intensity control unit 26 sets the emission intensity of the LEDs 14 when the judgment unit 23 judges that the disturbance light has an influence to be higher than the emission intensity when the judgment unit 23 judges that the disturbance light has no influence.

The RAM 40 has various memory areas for temporarily storing variable data. An offset voltage memory 80 is located in one of the memory areas. As shown in FIG. 4, offset voltages and flags are stored in the offset voltage memory 80 in accordance with the unique addresses [0] to [81] individually allocated to the phototransistors 15 disposed in the first and second light-receiving portions 13C and 13D. The flags are information to determine whether disturbance light more than a predetermined level has entered the phototransistor 15 identified by the corresponding unique address. In the present embodiment, the flag is set to “1” when disturbance light more than the threshold has entered, and the flag is reset to “0” otherwise.

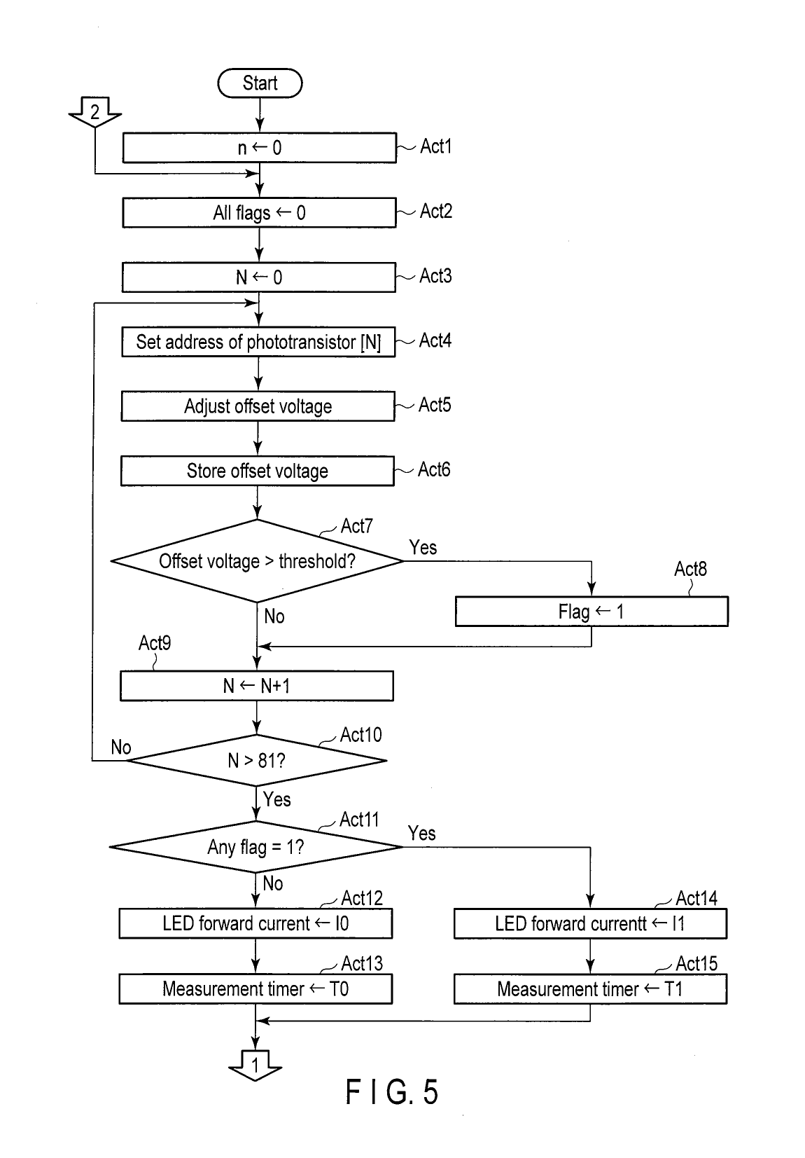

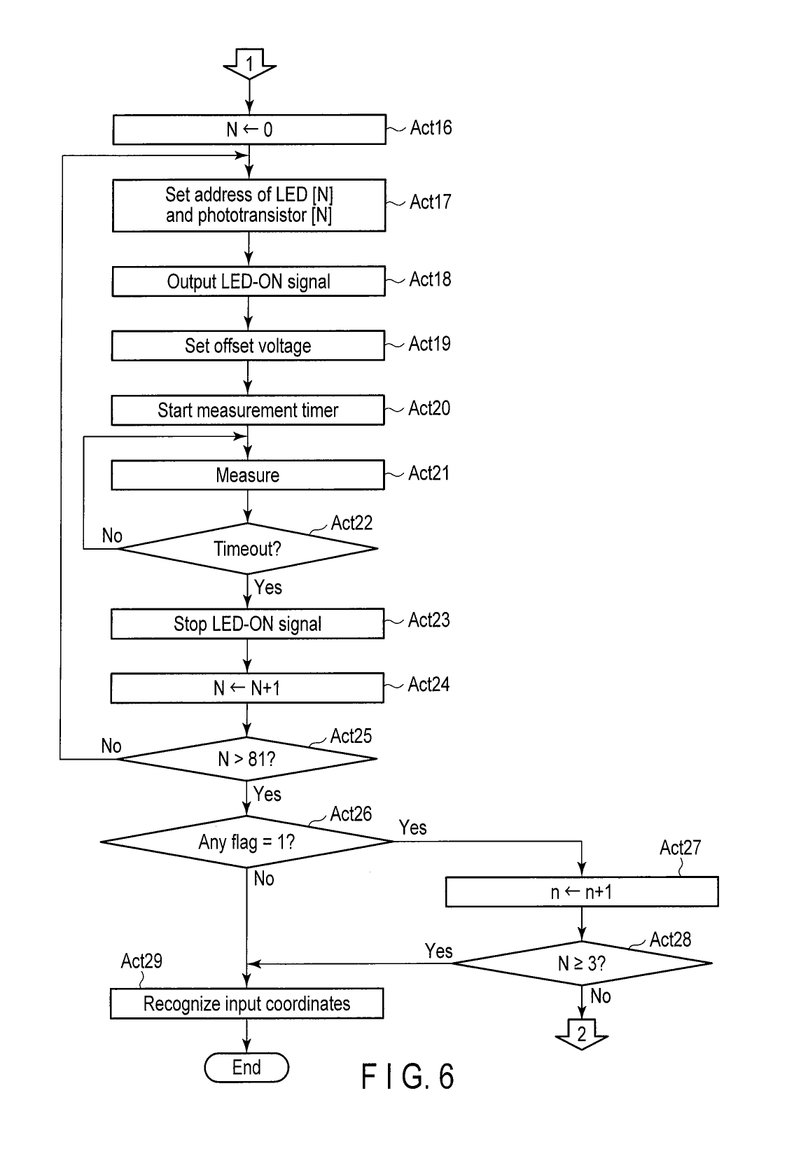

When the coordinate recognition program is started, the CPU 20 starts a processing routine shown in the flowcharts of FIG. 5 and FIG. 6. First, the CPU 20 initializes a retry counter n to “0” (Act 1). The CPU 20 also sets all the flags in the offset voltage memory 80 to “0” (Act 2). The CPU 20 also initializes an address counter N to “0” (Act 3). The retry counter n and the address counter N are formed in the RAM 40.

The CPU 20 acquires the value of the address counter N as the unique address to identify the phototransistor 15. Further, the CPU 20 outputs, to the second address decoder 65 and the second multiplexer 66, the address data P0 to P7 for selecting the phototransistor 15 of the unique address [N] (Act 4).

As the address data P0 to P7 are output, the sensor signal of the phototransistor 15 of the unique address [N] is selected by the second multiplexer 66. The selected sensor signal is input to the A/D converter 72 via the sensor amplifier 67 and the low pass filter 69.

The CPU 20 measures the output voltage of the sensor amplifier 67 from the sensor signal input to the A/D converter 72. The CPU 20 determines an adjustment value of the offset voltage so that the output voltage of the sensor amplifier 67 will be the reference voltage Vcc. Further, the CPU 20 outputs an adjustment signal corresponding to the adjustment value to the adjustment circuit 68 from the D/A converter 73. Thus, the CPU 20 adjusts the offset voltage by the feedback control based on the PID algorithm until the output voltage of the sensor amplifier 67 reaches a predetermined voltage, for example, 0.5 V (Act 5: the adjustment unit 21).

When the adjustment of the offset voltage is completed, the CPU 20 stores the adjustment value of the offset voltage in the area corresponding to the address [N] in the offset voltage memory 80 (Act 6).

The CPU 20 judges whether the adjustment value of the offset voltage is greater than a preset threshold (Act 7: the judgment unit 23). When the adjustment value is equal to or less than the threshold (NO in Act 7), the disturbance light has no influence on the phototransistor 15 of the unique address [N]. In this case, the CPU 20 does not change the flag corresponding to the address [N] in the offset voltage memory 80.

When the adjustment value is more than the threshold (YES in Act 7), the disturbance light has an influence on the phototransistor 15 of the unique address [N]. In this case, the CPU 20 changes the flag corresponding to the address [N] in the offset voltage memory 80 to “1” (Act 8).

The CPU 20 increases the address counter N by “1” (Act 9). The CPU 20 judges whether the address counter N has exceeded the unique address maximum value [81] of the phototransistor 15 (Act 10). When the address counter N has not exceeded the unique address maximum value [81] (NO in Act 10), the CPU 20 moves back to the processing in Act 4.

That is, the CPU 20 outputs, to the second address decoder 65 and the second multiplexer 66, the address data P0 to P7 for selecting the phototransistor 15 of the unique address [N]. Subsequently, the CPU 20 repeats the processing in and after Act 5.

The CPU 20 repeats the processing in Act 4 to Act 8 whenever the address counter N is increased (Act 9). If the address counter N has exceeded the unique address maximum value [81] (YES in Act 10), the CPU 20 searches the offset voltage memory 80 to judge whether there is any flag changed to “1” (Act 11).

When all the flags are not changed to “1” (NO in Act 11), the CPU 20 sets the LED forward current to a normal value I0 (Act 12). The CPU 20 also sets a timeout value of a measurement timer to a normal value T0 (Act 13).

In contrast, when at least one flag is changed to “1” (YES in Act 11), the CPU 20 sets the LED forward current to a value I1 higher than the normal value I0 (Act 14: the emission intensity control unit 26). The CPU 20 also sets the timeout value of the measurement timer to a value T1 which is one third of the normal value T0 (Act 15: the emission time control unit 25).

The CPU 20 again initializes the address counter N to “0” (Act 16). The CPU 20 acquires the value of the address counter N as the unique address to identify the LED 14 and the phototransistor 15. Further, the CPU 20 outputs, to the first address decoder 63 and the first multiplexer 64, the address data L0 to L7 for selecting the LED 14 of the unique address [N]. Similarly, the CPU 20 outputs, to the second address decoder 65 and the second multiplexer 66, the address data P0 to P7 for selecting the phototransistor 15 of the unique address [N] (Act 17).

The CPU 20 controls the D/A converter 71 to output the set value I0 or I1 of the LED forward current as an LED-ON signal (Act 18). The CPU 20 also acquires the adjustment value of the offset voltage from the area corresponding to the address [N] in the offset voltage memory 80. The CPU 20 controls the D/A converter 73 to output a voltage signal corresponding to the adjustment value to the adjustment circuit 68 (Act 19).

The CPU 20 starts the measurement timer (Act 20). The CPU 20 measures the voltage of the sensor amplifier 67 via the A/D converter 72 (Act 21). The measured voltage value is stored in the RAM 40 in association with the address [N] of the LED 14 and the phototransistor 15.

The CPU 20 judges whether the measurement timer has reached the timeout value T0 or T1 (Act 22). When the measurement timer has not reached the timeout value T0 or T1 (NO in Act 22), the CPU 20 continues the measurement. When the measurement timer reaches the timeout value T0 or T1 (YES in Act 22), the CPU 20 stops the LED-ON signal (Act 23).

The CPU 20 increases the address counter N by “1” (Act 24). The CPU 20 judges whether the address counter N has exceeded the unique address maximum value [81] (Act 25). When the address counter N has not exceeded the unique address maximum value [81] (NO in Act 25), the CPU 20 moves back to the processing in Act 17.

That is, the CPU 20 outputs, to the first and second address decoders 63 and 65 and the first and second multiplexers 64 and 66, the address data L0 to L7 and the address data P0 to P7 for selecting the LED 14 and the phototransistor 15 of the unique address [N]. Subsequently, the CPU 20 repeats the processing in and after Act 18.

The CPU 20 repeats the processing in Act 17 to Act 23 whenever the address counter N is increased (Act 24). If the address counter N has exceeded the unique address maximum value [81] (YES in Act 25), the CPU 20 searches the offset voltage memory 80 to judge whether there is any flag changed to “1” (Act 26).

When at least one flag is changed to “1” (YES in Act 26), the CPU 20 increases the retry counter n by “1” (Act 27). The CPU 20 judges whether the retry counter n has reached a limit value “3” for the number of retrials (Act 28).

When the retry counter n has not reached the limit value “3” (NO in Act 28), the CPU 20 moves back to the processing in Act 2. That is, the CPU 20 sets all the flags in the offset voltage memory 80 to “0”. Subsequently, the CPU 20 repeats the processing in and after Act 3 (the scan control unit 24).

When there is no flag changed to “1” in the offset voltage memory 80 in the processing in Act 26 (NO in Act 26) or when the retry counter n has reached the limit value “3” in the processing in Act 28 (YES in Act 28), the CPU 20 recognizes the X coordinate and the Y coordinate input by the coordinate input unit 10 (Act 29).

The CPU 20 recognizes the X coordinate and the Y coordinate on the basis of a measurement value by the sensor amplifier 67 stored in association with the address [N] of the LED 14 and the phototransistor 15. In this case, if more than one measurement value is stored by retry processing, an average value of the measurement values is calculated to recognize the X coordinate and the Y coordinate (the recognition unit 22).

In the present embodiment, the judgment unit 23 judges whether disturbance light received by the phototransistors 15 has an influence in accordance with the offset voltage value of the sensor amplifier 67 which amplifies the sensor signal output from the phototransistor 15. When the judgment unit 23 judges that the disturbance light has no influence, the scan control unit 24 sets the number of scans with the light beams to scan the coordinate input unit 10 to one. In contrast, when the judgment unit 23 judges that the disturbance light has an influence, the scan control unit 24 sets the number of scans to two or three. The recognition unit 22 recognizes the coordinates input by the coordinate input unit 10 in accordance with a change of the sensor signal.

Thus, when the judgment unit 23 judges that the disturbance light has an influence, the coordinate recognition apparatus 100 according to the present embodiment repeats scanning with the light beams more than one time to recognize input coordinates. In general, an error in coordinate recognition normally occurs only for a short period due to disturbance light such as sunlight that has entered the phototransistor 15. Therefore, the coordinate recognition apparatus 100 can increase the recognition rate of input coordinates even in an environment where the disturbance light has an influence.

Furthermore, in the present embodiment, when the judgment unit 23 judges that the disturbance light has an influence, the emission time control unit 25 sets the emission time of the LEDs 14 to be shorter than the emission time when the judgment unit 23 judges that the disturbance light has no influence. More specifically, if the emission time when the judgment unit 23 judges that the disturbance light has no influence is T0, the emission time T1 when the judgment unit 23 judges that the disturbance light has an influence is set to one third of the emission time T0.

As described above, when the disturbance light has an influence, the coordinate recognition apparatus 100 performs the scanning with the light beams a maximum of three times. That is, even if the scanning with the light beams is performed three times, the total time remains unchanged because the emission time T1 in this case is one third of the normal emission time T0. Therefore, even if scanning with the light beams is performed more than one time due to the influence of disturbance light, the coordinate recognition response performance does not deteriorate.

Moreover, in the present embodiment, the emission intensity control unit 26 sets the LED forward current to the value I1 higher than the normal value I0 when the disturbance light has an influence. That is, the emission intensity of the LEDs 14 is set to be higher than when the disturbance light is judged to have no influence.

Thus, when the disturbance light has an influence, the coordinate recognition apparatus 100 enhances the emission intensity of the LEDs 14, such that the S/N ratio can be improved. The phototransistor 15 is characterized by its response time that shortens as the emission intensity of the LEDs 14 increases. Therefore, even if the emission time of the LEDs 14 is reduced as described above, the emission intensity is increased to ensure that the sensor signal of the phototransistor 15 is detected. Consequently, the recognition rate of input coordinates does not decrease.

### Second Embodiment

A coordinate recognition apparatus 200 according to the second embodiment is different from the coordinate recognition apparatus 100 according to the first embodiment in part of the processing routine at the start of the coordinate recognition program. Thus, the second embodiment is described with reference to FIG. 1 to FIG. 6.

The coordinate recognition apparatus 200 according to the second embodiment omits the processing in Act 1, Act 26, Act 27, and Act 28 in the routine shown in the flowcharts of FIG. 5 and FIG. 6. That is, if the address counter N has exceeded the unique address maximum value [81] in the processing in Act 25 (YES in Act 25), the CPU 20 recognizes an X coordinate and a Y coordinate input by the coordinate input unit 10 (Act 29).

That is, when the disturbance light has an influence, the coordinate recognition apparatus 200 sets the emission intensity of the LEDs 14 to be higher than the emission intensity when the disturbance light has no influence. The coordinate recognition apparatus 200 also sets the emission time T1 when the disturbance light has an influence to be shorter than the emission time T0 when the disturbance light has no influence. The number of scans with the light beams is one regardless of whether the disturbance light has an influence.

In such a configuration as well, the emission intensity of the LEDs 14 is increased when the disturbance light has an influence, such that the S/N ratio is improved. Consequently, the coordinate recognition rate is increased.

### Third Embodiment

A coordinate recognition apparatus 300 according to the third embodiment is further different from the coordinate recognition apparatus 200 according to the second embodiment in part of the processing routine at the start of the coordinate recognition program. Thus, FIG. 1 to FIG. 6 are used again to describe the third embodiment.

The coordinate recognition apparatus 300 according to the third embodiment further omits the processing in Act 15 from the processing routine in the second embodiment. The processing in Act 14 is followed by the processing in Act 13. That is, when at least one flag is changed to “1” (YES in Act 11), the CPU 20 sets the LED forward current to the value I1 higher than the normal value I0 (Act 14: the emission intensity control unit 26). The timeout value of the measurement timer is the normal value T0.

That is, when disturbance light has an influence, the coordinate recognition apparatus 300 sets the emission intensity of the LEDs 14 to be higher than the emission intensity when the disturbance light has no influence. The emission time T1 of the LEDs 14 and the number of scans with the light beams remain the same regardless of whether the disturbance light has an influence.

In such a configuration as well, the emission intensity of the LEDs 14 is increased when the disturbance light has an influence, such that the S/N ratio is improved. Consequently, the coordinate recognition rate is increased.

### Other Embodiments

In the first embodiment described above, the number of retrials when the disturbance light is judged to have an influence is three, and the emission time of the LEDs 14 is one third of the normal emission time. These values (the number of retrials and the emission time) are not particularly limited. In addition, when the number of retrials is N (N≧2), the emission time can be 1/N of the normal emission time so that response characteristics equivalent to those when the disturbance light has no influence are obtained.

In the first embodiment described above, when measurement values of more than one scan are stored as a result of retrials, the coordinate recognition apparatus 100 recognizes an X coordinate and a Y coordinate from the average value of the measurement values (Act 29). Regarding this processing, the X coordinate and the Y coordinate may be recognized by means other than the average value, for example, by statistical means such as a median or a standard deviation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coordinate recognition apparatus comprising:
a coordinate input unit which inputs coordinates of a light-blocking position by the blockage of a light beam to scan a space between a light-emitting element and a light-receiving element that are disposed to face each other;
an adjustment unit which adjusts an offset voltage of a sensor amplifier that amplifies a sensor signal output from the light-receiving element;
a judgment unit which judges whether disturbance light received by the light-receiving element has an influence in accordance with an adjustment value of the offset voltage;
a scan control unit which sets the number of scans with the light beam to scan the coordinate input unit when the judgment unit judges that the disturbance light has an influence to be greater than the number of scans when the judgment unit judges that the disturbance light has no influence; and
a recognition unit which recognizes the coordinates input by the coordinate input unit in accordance with a change of the sensor signal output from the light-receiving element.

2. The apparatus of claim 1, wherein
the scan control unit sets the number of scans when the disturbance light is judged to have no influence to one, and the scan control unit sets the number of scans when the disturbance light is judged to have an influence to two or more.

3. The apparatus of claim 2, wherein
the recognition unit recognizes the coordinates from an average of changes of the sensor signals corresponding to the number of scans when the disturbance light is judged to have an influence.

4. The apparatus of claim 1, further comprising
an emission time control unit which sets the emission time of the light-emitting element when the judgment unit judges that the disturbance light has an influence to be shorter than the emission time when the judgment unit judges that the disturbance light has no influence.

5. The apparatus of claim 4, wherein
in the case where the scan control unit sets the number of scans when the disturbance light is judged to have an influence to N (N≧2), the emission time control unit sets the emission time when the disturbance light is judged to have an influence to be 1/N of the emission time when the disturbance light is judged to have no influence.

6. The apparatus of claim 1, further comprising
an emission intensity control unit which sets the emission intensity of the light-emitting element when the judgment unit judges that the disturbance light has an influence to be higher than the emission intensity when the judgment unit judges that the disturbance light has no influence.

7. The apparatus of claim 6, wherein
the light-emitting element is a light-emitting diode (LED), and
the emission intensity control unit sets a forward current of the LED when the judgment unit judges that the disturbance light has an influence to be higher than the forward current when the judgment unit judges that the disturbance light has no influence.

8. The apparatus of claim 6, further comprising
an emission time control unit which sets the emission time of the light-emitting element when the judgment unit judges that the disturbance light has an influence to be shorter than the emission time when the judgment unit judges that the disturbance light has no influence.

9. The apparatus of claim 8, wherein
in the case where the scan control unit sets the number of scans when the disturbance light is judged to have an influence to N (N≧2), the emission time control unit sets the emission time when the disturbance light is judged to have an influence to be 1/N of the emission time when the disturbance light is judged to have no influence.

10. The apparatus of claim 1, wherein
the coordinate input unit is an optical touch panel which comprises the light-emitting element and the light-receiving element that are disposed to face each other across a panel.

11. A coordinate recognition apparatus comprising:
a coordinate input unit which inputs coordinates of a light-blocking position by the blockage of a light beam to scan a space between a light-emitting element and a light-receiving element that are disposed to face each other;
an adjustment unit which adjusts an offset voltage of a sensor amplifier that amplifies a sensor signal output from the light-receiving element;
a judgment unit which judges whether disturbance light received by the light-receiving element has an influence in accordance with an adjustment value of the offset voltage;
an emission intensity control unit which sets the emission intensity of the light-emitting element when the judgment unit judges that the disturbance light has an influence to be higher than the emission intensity when the judgment unit judges that the disturbance light has no influence; and
a recognition unit which recognizes the coordinates input by the coordinate input unit in accordance with a change of the sensor signal output from the light-receiving element.

12. The apparatus of claim 11, wherein
the light-emitting element is a light-emitting diode (LED), and
the emission intensity control unit sets a forward current of the LED when the judgment unit judges that the disturbance light has an influence to be higher than the forward current when the judgment unit judges that the disturbance light has no influence.

13. The apparatus of claim 11, further comprising
an emission time control unit which sets the emission time of the light-emitting element when the judgment unit judges that the disturbance light has an influence to be shorter than the emission time when the judgment unit judges that the disturbance light has no influence.

14. The apparatus of claim 11, wherein
the coordinate input unit is an optical touch panel which comprises the light-emitting element and the light-receiving element that are disposed to face each other across a panel.

15. A coordinate recognition method using a coordinate input unit which inputs coordinates of a light-blocking position by the blockage of a light beam to scan a space between a light-emitting element and a light-receiving element that are disposed to face each other, a judgment unit, a scan control unit and a recognition unit, the method comprising:
causing the judgment unit to judge whether disturbance light received by the light-receiving element has an influence in accordance with an adjustment value of an offset voltage of a sensor amplifier that amplifies a sensor signal output from the light-receiving element;
causing the scan control unit to set the number of scans with the light beam to scan the coordinate input unit when the judgment unit judges that the disturbance light has an influence to be greater than when the judgment unit judges that the disturbance light has no influence; and
causing the recognition unit to recognize the coordinates input by the coordinate input unit in accordance with a change of the sensor signal output from the light-receiving element.

16. The method of claim 15, wherein
the scan control unit sets the number of scans when the disturbance light is judged to have no influence to one, and the scan control unit sets the number of scans when the disturbance light is judged to have an influence to two or more.

17. The method of claim 16, wherein
the recognition unit recognizes the coordinates from an average of changes of the sensor signals corresponding to the number of scans when the disturbance light is judged to have an influence.

18. The method of claim 15, further comprising
causing an emission time control unit to set the emission time of the light-emitting element to be shorter when the judgment unit judges that the disturbance light has an influence than when the judgment unit judges that the disturbance light has no influence.

19. The method of claim 18, wherein
in the case where the number of scans when the disturbance light is judged to have an influence is N (N≧2), the emission time control unit sets the emission time when the disturbance light is judged to have an influence to be 1/N of the emission time when the disturbance light is judged to have no influence.

20. The method of claim 15, further comprising
causing an emission intensity control unit to set the emission intensity of the light-emitting element to be higher when the judgment unit judges that the disturbance light has an influence than when the judgment unit judges that the disturbance light has no influence.
